(19) United States
(12) Patent Application Publication
(10) Pub. No.: US 2004/0059800 A1
(43) Pub. Date: Mar. 25, 2004

(54) Device storage of network information

(75) Inventors: Mark L. Hanson, Tigard, OR (US); David M. Chapin, Gresham, OR (US)

Correspondence Address: Patent Documentation Center, Xerox Corporation, Xerox Sq. 20th Floor, 100 Clinton Avenue South, Rochester, NY, 14644, US

(73) Assignee: Xerox Corporation

(21) Appl. No.: 10/251,511

(22) Filed: Sep. 19, 2002

(51) Int. Cl. G06F 15/177

(52) U.S. Cl. 709/220

(57) ABSTRACT

A non-infrastructure network device such as a printer that includes a memory for storing sub-network identifying information received from a network device such as a host device.

### BACKGROUND OF THE DISCLOSURE

The disclosure relates generally to non-infrastructure network devices such as printers, and more particularly to a non-infrastructure network device such as a printer that includes a memory for storing network related information received from a network device such as a host device.

Installing a network printer on a host device commonly involves identifying a network printer to be installed on the host device, and then installing a printer driver on the host device so that print jobs can be sent to the installed printer. Installing other non-infrastructure network devices can involve similar procedures. Sometimes, it can be difficult to unambiguously identify the printer or other non-infrastructure network device to be installed.

### BRIEF DESCRIPTION OF DRAWINGS

FIG. 1 is a schematic block diagram of an embodiment of a networked system that includes a non-infrastructure network device such as a printer, multi-function device or scanner.

FIG. 2 is a schematic block diagram of an embodiment of a printer that can be connected to a network.

FIG. 3A and FIG. 3B set forth a schematic flow diagram of an embodiment of a procedure for installing a printer on a host device.

FIG. 4 is a schematic illustration of an embodiment of a dialog box that can be used to prompt a user in the course of installing a networked printer on a host device.

FIG. 5 is a schematic flow diagram of an embodiment of another procedure for installing a printer on a host device.

FIG. 6 is a schematic flow diagram of an embodiment of another procedure for installing a printer on a host device.

### DETAILED DESCRIPTION OF THE DISCLOSURE

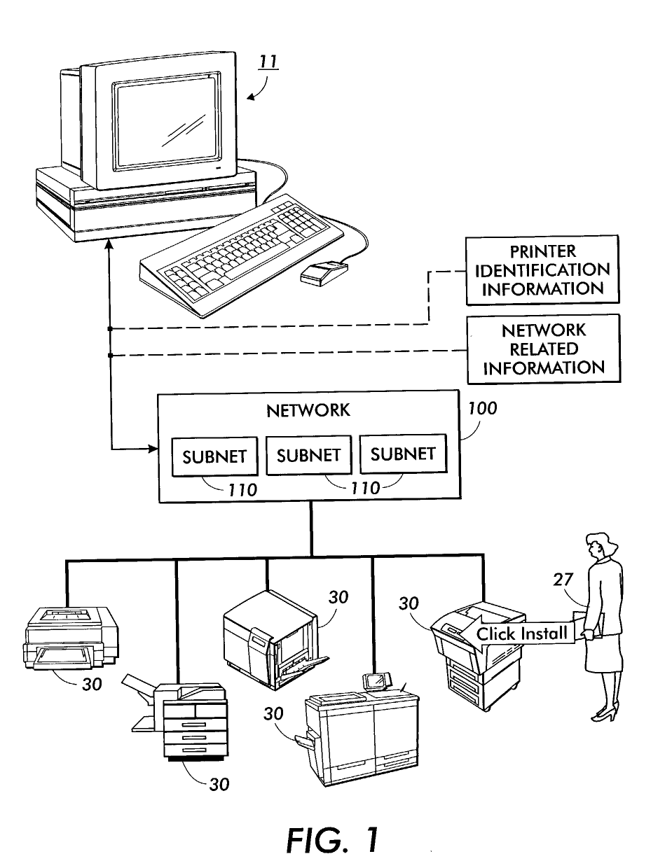

FIG. 1 is a schematic block diagram of an embodiment of a networked system that includes a network 100 that is comprised of a plurality of subnets 110, a host device 11 that is connected to one of the subnets 110, and at least one non-infrastructure network device 30 such as a printer, multi-function device or scanner, each of which is connected to an associated subnet 110. For reference, infrastructure devices would include routers and hubs. While the disclosed systems and procedures can be employed with non-infrastructure network devices such as printers, multi-function devices and scanners, the following discussion will be directed primarily to printers for convenience. The host device 11 can be a personal computer or a workstation that can be controlled by a user 27 to install a non-infrastructure network device on the host device 11. By install, it is meant that the user desires to configure the host device 11 to be able to communicate with the installed non-infrastructure network device, for example to be able to send print jobs to an installed printer. This can be accomplished for example by installing an appropriate device driver on the host device 11.

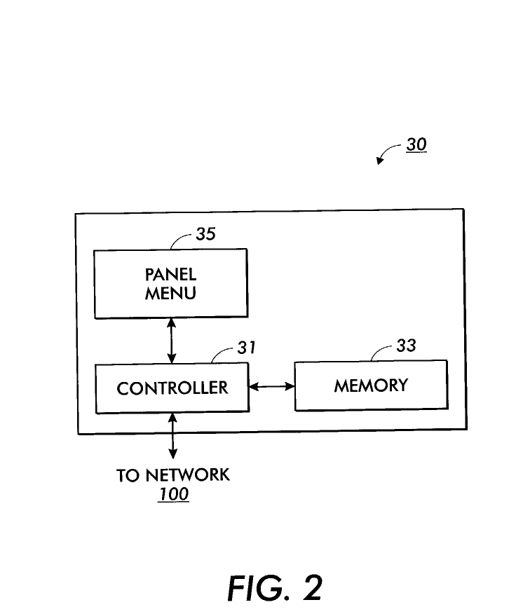

FIG. 2 is a schematic block diagram of an embodiment of a printer 30 that can be connected to the network 100. The printer includes a controller 31 for controlling the operation of the printer and a memory 33 that can comprise non-persistent memory such as random access memory (RAM) or cache, and/or non-persistent memory such as a hard drive or non-volatile random access memory (NVRAM). For example, the controller 31 stores data in the memory 33 and retrieves data from the memory 33. The controller 31 is also configured to be connected to the network 100 for sending and receiving network messages (e.g., communications packets). The printer can further include a panel menu 35 for receiving inputs from a user, for example. The printer can also include a web server.

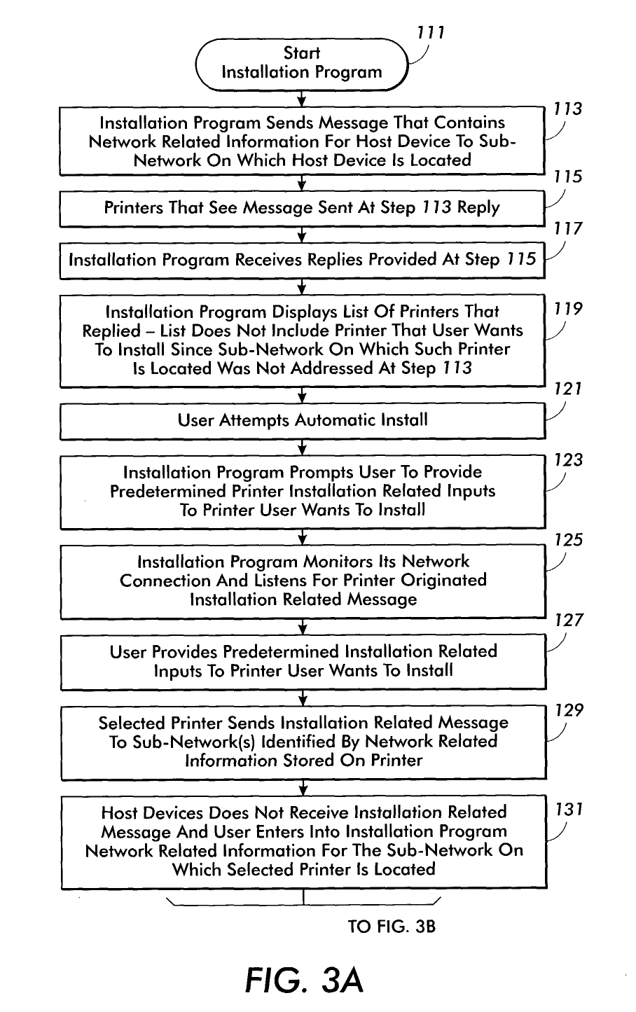

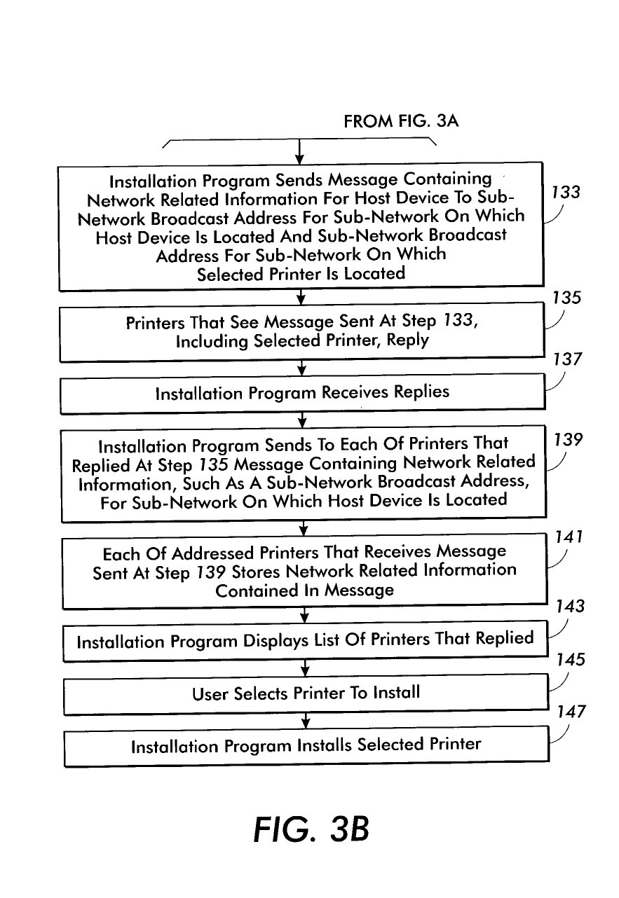

FIGS. 3A-3B set forth a schematic flow diagram of an embodiment of a procedure for installing a network printer on the host device 11 (FIG. 1), for the example wherein the network printer that the user wants to install is not on the same sub-network as the host device and does not know of the sub-network on which the host device is located. At 111 an installation program is started, for example from a location on a storage media (such as a CD, DVD, or hard drive on the host device 11 itself) or from remote location such as a location on the Internet or from a printer's embedded web server. By way of illustrative example, the installation program can be configured to be started from a web browser such as Internet Explorer or Netscape. Also by way of illustrative example, the installation program can be downloaded to the host device from a remote location such as an embedded web server of one of the printers 30. If the installation program is downloaded from a printer's web page, that web page can be on the printer that the user wants to install or can be from another printer that the desired printer is pointing to.

At 113 the installation program sends a message that contains the network related information for the host device to a sub-network broadcast address for the sub-network on which the host device is located.

At 115 the printers that see the message sent at 113 reply. The printer that the user wants to install does not reply since it is on a sub-network that was not addressed at 113.

At 117 the installation program receives the replies provided at 115.

At 119 the installation program displays a list of printers that replied. This list does not include the printer the user wants to install since the sub-network on which such printer is located was not addressed at 113.

At 121 the user attempts an automatic install since the printer the user wants to install is not on the displayed list of printers.

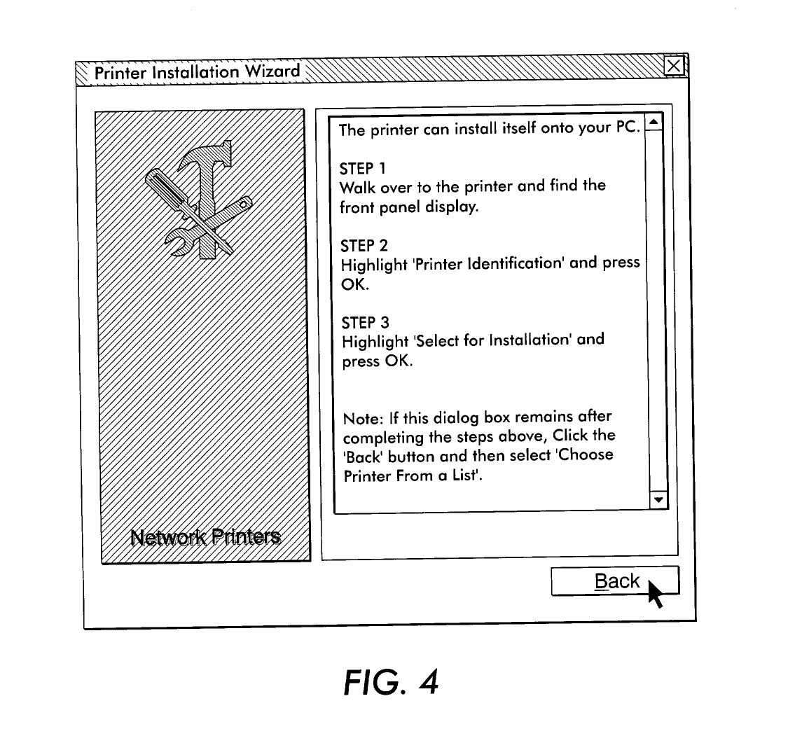

At 123 the installation program prompts the user, for example by a dialogue box like the one shown in FIG. 4, to go to the printer the user wants to install on the host device 11 and to provide predetermined printer installation related inputs to the selected printer. Such inputs can be made by selections on the panel menu 35 (FIG. 2) of the printer the user wants to install, for example.

At 125 the installation program begins monitoring its network connection for a period of time and listens for a printer originated installation related message containing certain printer identification information. This identification information can be for example the model name and distinguishing information for the printer. It may also be the printer's IP address and configuration data needed to install the printer. If the installation program can install more than one type of printer, the model information and other configuration information may be needed to determine which printer driver should be installed.

At 127 the user provides predetermined installation related inputs to the printer the user wants to install, for example by making selections from the panel menu 35 of the selected printer.

At 129 the selected printer sends to sub-network(s) identified by network related information stored on the selected printer an installation related message that contains whatever information has been stored for broadcasting. This installation related message more particularly contains printer identification information that the host device 11 is listening for. This printer identification information contains sufficient printer identifying information for the host device 11 to identify which printer sent it, and can include for example the IP address of the selected printer.

At 131, the host device does not receive the installation related message and the user enters into the installation program the network information for the sub-network on which the selected printer is located. The host device did not receive the installation related message since the selected printer did not have the network related information for sub-network on which the host device is located and thus did not send the installation related message to the sub-network on which the host is located.

At 133 the installation program sends a message containing the network related information of the host device to the sub-network broadcast address for the sub-network on which the host device is located and the sub-network broadcast address for the sub-network on which the selected printer is located.

At 135 the printers that see the message sent at 133, including the selected printer, reply.

At 137 the installation program receives the replies provided at 135.

At 139 the installation program sends to each of the printers that replied at 135 a message containing network related information, such as a sub-network broadcast address, for the sub-network on which the host device is located.

At 141 each of the addressed printers that receive the message sent at 139 stores the network related information contained in the message sent at 139.

At 143 the installation program displays a list of the printers that replied. This list includes the selected printer.

At 145 the user selects the printer to install.

At 147 the installation program installs the selected printer.

In this manner, the selected printer (or other non-infrastructure network device) can thus in the future send installation related messages to the sub-network on which the host device 11 is located. Also, an installation program can query a printer or other non-infrastructure network device for network related information stored on the printer or other non-infra-structure network device to help the installation program to find networked printers or other non-infrastructure network devices for presentation to the user, for example.

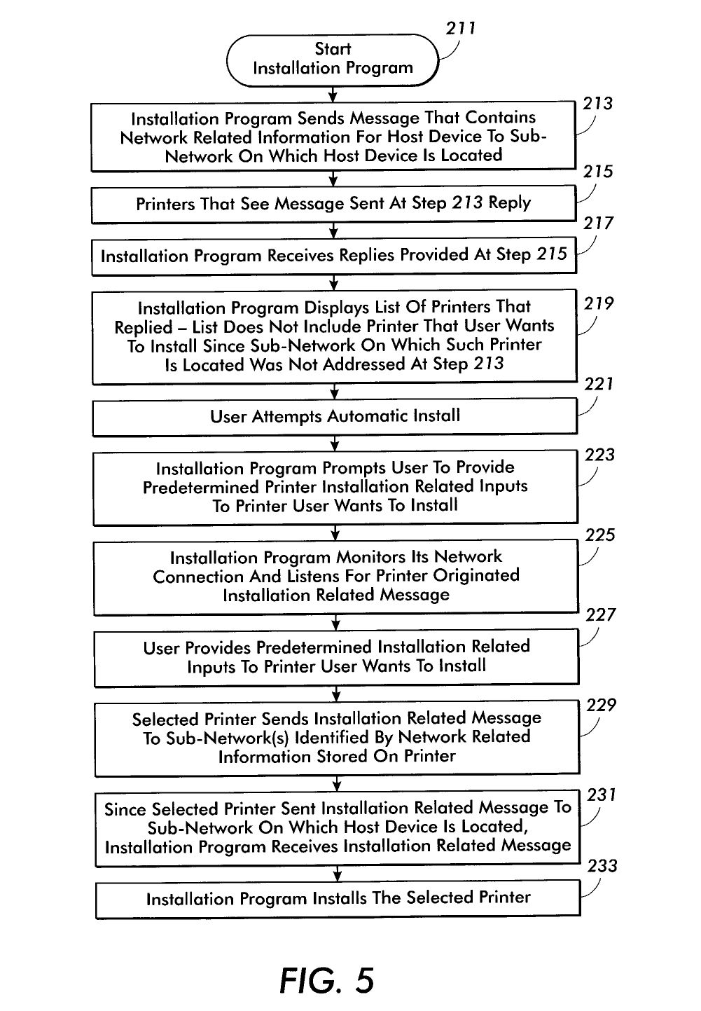

FIG. 5 is a schematic flow diagram of an embodiment of a procedure for installing a printer on the host device 11 (FIG. 1), for the example wherein the printer that the user wants to install is not on the same sub-network as the host device but knows of the sub-network on which the host device is located, for example by having previously stored network related information for the sub-network of the host device.

At 211 the installation program is started.

At 213 the installation program sends a message that contains the network related information of the host device to a sub-network broadcast address for the host device.

At 215 the addressed printers that see the broadcasted network related information reply. The printer that the user wants to install does not reply since it is on a sub-network that was not addressed at 213.

At 217 the installation program receives the replies provided at 215.

At 219 the installation program displays a list of printers that replied. This list does not include the printer the user wants to install since the sub-network on which such printer is located was not addressed at 213.

At 221 the user attempts an automatic install since the printer the user wants to install is not on the displayed list of printers.

At 223 the installation program prompts the user, for example by a dialogue box like the one shown in FIG. 4, to go to the printer the user wants to install on the host device 11 and to provide predetermined printer installation related inputs to the selected printer. Such inputs can be made by selections on the panel menu 35 (FIG. 2) of the printer the user wants to install, for example.

At 225 the installation program begins monitoring its network connection for a period of time and listens for a printer originated installation related message containing certain printer identification information. This identification information can be for example the model name and distinguishing information for the printer. It may also be the printer's IP address and configuration data needed to install the printer. If the installation program can install more than one type of printer, the model information and other configuration information may be needed to determine which printer driver should be installed.

At 227 the user provides predetermined installation related inputs to the printer the user wants to install, for example by making selections from the panel menu 35 of the selected printer.

At 229 the selected printer sends to sub-network(s) identified by network related information stored on the selected printer an installation related message that contains whatever information has been stored for broadcasting. This installation related message more particularly contains printer identification information that the host device 11 is listening for. This printer identification information contains sufficient printer identifying information for the host device 11 to identify which printer sent it, and can include for example the IP address of the selected printer.

At 231, since the selected printer sent the installation related message to the sub-network on which the host device is located, the installation program receives the installation related message.

At 233 the installation program installs the selected printer. For example, the installation program installs a driver for the selected printer, and communicates with the selected printer over the network 100 (FIG. 1) using a suitable network protocol such as TCP/IP.

Thus, a network printer or other non-infrastructure network device such as a scanner can store, for example in a persistent memory, identifying information about sub-networks other than the sub-network on which the printer or other non-infrastructure network device is located.

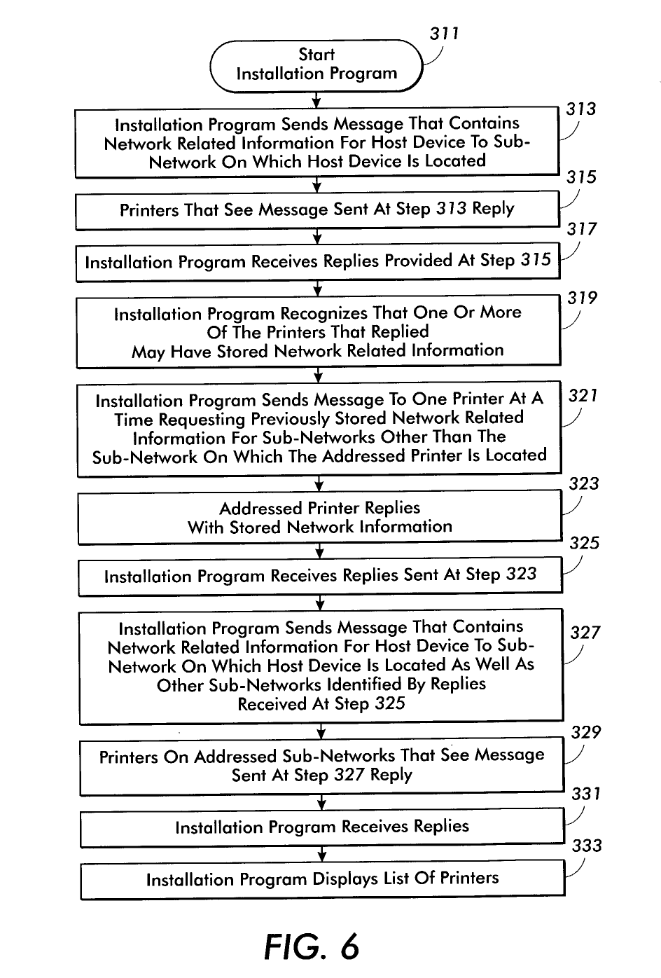

FIG. 6 is a schematic flow diagram of an embodiment of a procedure for installing a network printer on the host device, for the example wherein one or more printers on the network have stored network related information.

At 311 an installation program is started.

At 313 the installation program sends a message that contains network related information for the host device to a sub-network broadcast address for the host device.

At 315 the addressed printers that see the message sent at 313 reply.

At 317 the installation program receives the replies provided at 315.

At 319 the installation program recognizes that one or more of the printers that replied may have stored network related information.

At 321 the installation program sends a message to one replying printer at a time requesting stored network related information for sub-networks other than the sub-network on which the replying printer is located.

At 323 each addressed printer replies with stored network related information.

At 325 the installation program receives the replies sent at 323.

At 327 the installation program sends a message that contains network related information for the host device to the sub-network on which the host device is located as well as other sub-networks identified by the replies received at 325.

At 329 the printers on the addressed sub-networks that receive the message sent at 327 reply.

At 331 the installation program receives the replies.

At 333 the installation program displays a list printers.

The user can then proceed as in the procedures of FIGS. 3A-3B or FIG. 5, as appropriate.

The invention has been described with reference to disclosed embodiments, and it will be appreciated that variations and modifications can be affected within the spirit and scope of the invention.

What is claimed is:

1. A printer comprising:
a printer controller configured to be connected to a first sub-network of a network for receiving network information for a second sub-network of the network from a network device located on the network; and
a printer memory for storing the network information for the second sub-network.

2. The printer of claim 1 wherein the printer memory comprises a persistent memory.

3. The printer of claim 1 wherein the network information for the second sub-network comprises a broadcast address for the second sub-network.

4. The printer of claim 1 wherein the network information for the second sub-network is received from a host device.

5. The printer of claim 1 wherein the network information for the second sub-network is received from a host device that is installing a different printer.

6. The printer of claim 1 further including a web server that is resident on the printer.

7. A printer comprising:
a controller configured to be connected to a first sub-network of a network for receiving network information for a second sub-network of the network from a network device located on the network, and for sending a message containing identification information for the printer to the second sub-network; and
a printer memory for storing the network information for the second sub-network.

8. The printer of claim 7 wherein the printer memory comprises a persistent memory.

9. The printer of claim 7 wherein the network information for the second sub-network comprises a broadcast address for the second sub-network.

10. The printer of claim 7 wherein the network information for the second sub-network is received from a host device.

11. The printer of claim 7 wherein the network information for the second sub-network is received from a host device that is installing a different printer.

12. The printer of claim 7 wherein the identification information for the printer comprises the printer's model name and distinguishing network information.

13. The printer of claim 7 wherein the identification information for the printer comprises an IP address.

14. The printer of claim 7 further including a web server that is resident on the printer.

15. A printer comprising:
a controller configured to be connected to a first sub-network of a network for receiving network information for a second sub-network of the network from a network device located on the network, and for sending a message to the second sub-network; and
a printer memory for storing the network information for the second sub-network.

16. The printer of claim 15 wherein the printer memory comprises a persistent memory.

17. The printer of claim 15 wherein the network information for the second sub-network comprises a broadcast address for the second sub-network.

18. The printer of claim 15 wherein the network information for the second sub-network is received from a host device.

19. The printer of claim 15 wherein the network information for the second sub-network is received from a host device that is installing a different printer.

20. The printer of claim 15 further including a web server that is resident on the printer.

21. A non-infrastructure network device comprising:
a device controller configured to be connected to a first sub-network of a network for receiving network information for a second sub-network of the network from a network device located on the network; and
a device memory for storing the network information for the second sub-network.

22. The non-infrastructure network device of claim 21 wherein the printer memory comprises a persistent memory.

23. The non-infrastructure network device of claim 21 wherein the network information for the second sub-network comprises a broadcast address for the second sub-network.

24. The non-infrastructure network device of claim 21 wherein the network information for the second sub-network is received from a host device.

25. The non-infrastructure network device of claim 21 wherein the network information for the second sub-network is received from a host device that is installing a different non-infrastructure network device.

26. A non-infrastructure network device comprising:
a device controller configured to be connected to a first sub-network of a network for receiving network information for a second sub-network of the network from a network device located on the network, and for sending a message containing identification information for the non-infrastructure network device to the second sub-network; and
a device memory for storing the network information for the second sub-network.

27. The non-infrastructure network device of claim 26 wherein the device memory comprises a persistent memory.

28. The non-infrastructure network device of claim 26 wherein the network information for the second sub-network comprises a broadcast address for the second sub-network.

29. The non-infrastructure network device of claim 26 wherein the network information for the second sub-network is received from a host device.

30. The non-infrastructure network device of claim 26 wherein the network information for the second sub-network is received from a host device that is installing a different non-infrastructure device.

31. The non-infrastructure network device of claim 26 wherein the identification information for the non-infrastructure network device comprises the device's model name and distinguishing network information.

32. The non-infrastructure network device of claim 31 wherein the identification information for the non-infrastructure network device comprises an IP address.

33. A non-infrastructure network device comprising:
a device controller configured to be connected to a first sub-network of a network for receiving network information for a second sub-network of the network from a network device located on the network, and for sending a message to the second sub-network; and
a device memory for storing the network information for the second sub-network.

34. The non-infrastructure network device of claim 33 wherein the printer memory comprises a persistent memory.

35. The non-infrastructure network device of claim 33 wherein the network information for the second sub-network comprises a broadcast address for the second sub-network.

36. The non-infrastructure network device of claim 33 wherein the network information for the second sub-network is received from a host device.

37. The non-infrastructure network device of claim 33 wherein the network information for the second sub-network is received from a host device that is installing a different non-infrastructure network device.
